(19) United States
(12) Patent Application Publication
(10) Pub. No.: US 2025/0307924 A1
(43) Pub. Date: Oct. 2, 2025

(54) DEVICE WITH A FULLY AUTOMATED AI DUAL-SELL BALANCED OPTIONS (FUTURES) TRADING PROGRAM

(71) Applicant: Chang-Hao CHUEN, New Taipei City (TW)

(72) Inventor: Chang-Hao CHUEN, New Taipei City (TW)

(21) Appl. No.: 19/094,059

(22) Filed: Mar. 28, 2025

(30) Foreign Application Priority Data
Mar. 28, 2024 (TW) 113111610

(51) Int. Cl. G06Q 40/04

(52) U.S. Cl. CPC G06Q 40/04

(57) ABSTRACT

A device with a fully automated AI dual-sell options (futures) balancing trading program is disclosed. The device generates a user interface comprising a total Delta value balance setting area that includes a first total Delta balance value setting column one, a first total Delta balance value setting column two, a first buy-sell strike setting column, a first dynamic automatic price-adjustment setting column, a first order quantity setting column, and a first automatic order time interval setting column; a total Delta value balance module, wherein when the total Delta value exceeds a range, the total Delta value balance module transmits an order to an automatic order placement integration module for placement based on the parameters set in the first buy-sell strike setting column, the first dynamic automatic price-adjustment setting column, the first order quantity setting column, and the first automatic order time interval setting column.

### BACKGROUND

### 1. Technical Column

The disclosure relates to a technology for an options program trading system applied to computer devices, specifically a fully automated artificial intelligence (AI) dual-sell balanced options (futures) trading program.

### 2. Background

In the securities trading market, financial instruments are classified based on their rights characteristics into stock-based financial instruments, futures-based financial instruments, and options-based financial instruments, each representing different rights and obligations. Among them, “stocks” represent ownership of financial assets, “futures” are contracts to buy or sell financial instruments at a predetermined price on a specific future date, and “options” are contracts granting buyers the right to buy or sell financial instruments at a specified price within a specified period. Currently, all these financial instruments can be traded through financial instrument order placement software or by using automated trading programs to place orders with securities and futures companies or futures companies.

Options-based financial instruments (e.g., stock index options, specific company stock index options) involve different rights such as buy, sell, call (that is, the right to purchase underlying assets in the future), and put (that is, the right to sell underlying assets in the future). The “call” is also called “call options”, and the “put” is also called “put options” throughout the disclosure. This gives rise to unique trading strategies, including buy call, buy put, sell call, and sell put. Furthermore, options trading has evolved into numerous advanced strategies (combination strategies), such as bull call spreads, bear call spreads, bull put spreads, bear put spreads, long straddles, long strangles, short straddles, short strangles, buy calendar spreads, sell calendar spreads, sell butterfly spreads, buy-sell butterfly spreads, and buy condor spreads and sell condor spreads, among others. Mastering these trading strategies is fundamental when using an automated trading program. Since options trading involves complex concepts, developing an automated options trading program is relatively challenging. This is due to the numerous parameters that must be considered, the varied inputs required for order placement, and the different statistical parameters necessary for post-trade analysis. In other words, designing an appropriate automated options trading system is not an easy task.

Generally, when a user designs an automated options trading program for personal use, they must follow several steps. First, the user needs to select the financial instrument and its expiration date. For example, the user may choose TAIEX options, electronic options, or financial options, including individual stock options such as TSMC or UMC options, as well as international financial options like gold or silver options. Each expiration date corresponds to a different product, such as monthly expiration labeled as TX0, first-week expiration as TX1, second-week expiration as TX2, and so on. In step 1, the user must determine the trading strategy, price, and contract quantity; after selecting the financial instrument, they proceed by choosing an appropriate trading strategy. In step 2, the user decides on the strike price, such as an index at 18,500, and sets the order type as either a “market price,” which executes at the current available price, or a “limit price,” where they specify a desired price, and the order quantity must be defined. In step 3, once these parameters are set, the user uploads the order for placement. If the trade is not completed, they can either leave the order pending or cancel it. In step 4, when the trade is successfully executed, the system records the number of contracts traded. In step 5, the user decides whether to close the position or wait for settlement. In step 6, statistical analysis is conducted to determine the execution status of the automated options trading program. Within these steps, there are additional details to consider, such as margin calculations for sold contracts, tracking the number of orders bought and sold, recording price point movements, calculating transaction fees, and analyzing market quote information for financial instruments. For example, stock index options use a “T-shaped quote” format, which provides strike prices for both call and put options. For programmers developing an automated options trading program, it is essential to fully understand every detail before proceeding with coding. Before an automated options trading program is officially put into operation, the programmer usually conducts back-testing. This involves simulating the performance of the trading program using historical transaction data from the stock exchange or modeling the current market conditions to evaluate its effectiveness. Based on the results, they refine their trading strategy accordingly. Regarding the design of buy and sell prices, historical back-testing can only use the “transaction price,” or market price, rather than a “limit price” because past transactions cannot be revisited to verify whether a limit order would have been executed. Similarly, when simulating the current market conditions, only the transaction price can be used, not the limit price. In actual trading, a combination of market and limit pricing is used. Therefore, when an automated options trading program is executed in real trading, a predetermined price—either market price or limit price—is set before the program runs.

Taking the Taiwan Index options as an example, since it is a contract based on the Taiwan Stock Exchange Capitalization-Weighted Stock Index, its market price fluctuates dynamically with changes in the index. Additionally, the current price of different strike prices (index levels) is constantly changing. As a result, setting an automated trade with a “limit price” often leads to unsuccessful transactions. The challenge in developing an automated options trading program lies in enabling users to select a “dynamic price” that allows the system to generate orders automatically and execute trades based on their strategy. Using a “market price” ensures faster execution but may result in unfavorable prices for the trader. On the other hand, setting a “limit price” can help secure a better price but significantly reduces the likelihood of execution, potentially missing market opportunities. This presents a fundamental dilemma in designing an automated options trading program. When trading options, there are three order placement conditions: ROD (Rest of Day) refers to a “day order,” meaning the order remains valid until the market closes on the same day, as long as the trader does not cancel it. When an investor places a limit order, the system typically defaults to an ROD order. IOC (immediate-or-Cancel) means “execute immediately or cancel.” once the order is placed, any portion that can be immediately executed will be filled, while the remaining unfilled portion is canceled; when a trader places a market order, the system automatically sets it as an IOC order. FOK (Fill-or-Kill) requires the order to be fully executed immediately, or it will be canceled, and this means that if the entire order cannot be filled at once, it is canceled entirely. In summary, limit orders are generally ROD orders, while market orders are typically IOC orders.

In addition, as mentioned earlier, options trading strategies are quite diverse. Unlike stock or futures financial products, which only have basic buy and sell strategies, options allow for a variety of strategies that involve both buying and selling simultaneously. Each of these strategies has different prices, margin requirements, and other factors. The margin calculation formula is as follows: margin=option premium value+Max (A value−out-of-the-money value, B value), where: for call options, the out-of-the-money value is calculated as Max[(strike price−underlying index price)×contract multiplier, 0]; for put options, the out-of-the-money value is calculated as Max[(underlying index price−strike price)×contract multiplier, 0]. In other words, options also have the complex concepts of “in-the-money value” and “out-of-the-money value,” which make the basic information about options more intricate. As a result, writing an automated options trading program becomes more challenging, and making the various parameters of the program user-friendly is even more difficult. Even if the developers of these programs interface with the parameters, they are unlikely to make it public. This is because the purpose of writing the program is for personal use, to facilitate automated trading efficiently and conveniently, rather than for others. Consequently, there is almost no publicly available information about the user interfaces of automated options trading programs, and this is kept as a trade secret by the program developers. Therefore, how to make the parameters of an automated options trading program user-friendly, allowing traders to easily select strategies such as position-building, stop-loss, price, and buy-sell strategies through a visual user interface, becomes an important challenge for the program developers. This is especially crucial if the automated options trading program is to be made public and shared with a wider community of options traders.

In addition, options have a unique trading model known as the seller's trading (also referred to as market-making in some contexts), where the seller is required to deposit a margin. The margin calculation formula has been mentioned previously, so it will not be repeated here. Sellers have various strategies, such as sell call, sell put, bull call spreads, bull put spreads, bear call spreads, bear put spreads, sell straddles, sell strangles, buy time spreads, sell time spreads, buy butterfly spreads, sell butterfly spreads, buy condor spreads, and sell condor spreads, among others. Among these strategies, sell call, sell put, sell straddles, and sell strangles require a higher margin. In contrast, other combination strategies, which involve buying call or put options, generally require lower margins. In other words, in seller trading, besides acting as a seller, one can also simultaneously take on the role of a buyer, which leads to a variety of different combination strategies. These different strategy orders can be directly placed as orders with the securities and futures companies. Similarly, an automated options trading program can use the application programming interface (API) provided by the securities and futures companies to place combination strategy orders. However, in terms of execution difficulty, combination strategy orders are more complex. Since they involve two strike prices, and each strike price has its own price and contract size, the difficulty of execution is higher compared to simple buy and sell orders. From the perspective of the automated options trading program, if the order cannot be executed, no matter how good the program is, it becomes ineffective. Therefore, the designers of automated options trading programs tend to use a strategy that ensures the order can actually be executed. Otherwise, even if a trading model with a perfect return rate is developed, it becomes useless if the orders cannot be filled. This is a crucial consideration in the design of an automated options trading program. From the perspective of execution ease, program designers often prefer to place individual orders for each combination strategy or place separate buy or sell orders individually. Afterwards, they combine these strategies to increase the likelihood of execution.

After setting the automated trading strategy, reducing risk (hedge) and maximizing profit becomes a primary focus for every algorithmic trader. This is especially important after the transaction is executed, as the market for options financial products continues to change. From this perspective, automated options trading program designers tend to manage the risk of each trade individually. In other words, they set stop-loss points for each executed trade. Once the stop-loss condition is met, the position is closed. For example, on the buyer's side, since the buyer's call or put option includes both time value and intrinsic value (the option's value consists of “intrinsic value,” which is the value of exercising the option immediately), the buyer can determine a strategy based on these values to manage risk and protect potential profits. “Time value” represents the “future potential value” of an option. As time passes, the time value gradually diminishes, or in the event of a sharp rise or drop in the index, the buyer must decide whether to close the position to avoid significant losses. Similarly, sellers must also consider the potential risks of large margin losses if the index moves sharply. This issue becomes more pronounced when the number of contracts bought or sold increases. In other words, when an options trader's position grows in size—such as holding hundreds, thousands, or even tens of thousands of contracts—the risk of a system failure increases. If individual trade monitoring is applied, the program might become overwhelmed by too many monitoring points, leading to potential crashes due to insufficient computer hardware or software processing capacity. Therefore, developing an effective automatic risk management method for automated options trading programs has become a significant challenge for program designers. Currently, no effective risk control techniques for large-volume trades have been disclosed publicly. Similarly, these techniques remain trade secrets for large-scale automated traders (referred to as “whales” in the industry).

Additionally, automated options traders, when they have sold multiple calls or put options across different strike prices, may encounter a situation where they cannot continue with automated trading due to insufficient margin. Therefore, enabling the automated options trading program to monitor the margin balance and optimize it through margin recovery methods is a crucial consideration. This approach helps maximize the use of available capital and increase the number of contracts executed. How to optimize margin management to enhance trading capacity is one of the key challenges for automated options trading program designers.

### SUMMARY

In view of the foregoing, the disclosure utilizes an options application programming interface (API) provided by securities and futures companies to develop an automated options trading program. By using various custom parameters to redefine the input values in the user interface, the disclosure allows options traders to easily enter their desired options order strategies through the user interface. Furthermore, the disclosure includes multiple modules for the balance strategy of options sellers, enabling users to effortlessly input parameters and implement risk management for large-scale trades. This allows options traders to simultaneously achieve a balance between strategy trading and risk control, significantly reducing the risks associated with large-volume trades and improving the overall success rate of options trading.

To achieve the objective, the disclosure provide a device with a fully automated AI dual-sell options (futures) balancing trading program, wherein the device comprises a memory and a screen and is connected to a server, and the device comprises: a communication module, configured to establish an Internet network connection, and connected to the server; a program-trading connection module; a screen interface generation module, configured to generate a user interface on the screen, wherein the user interface at least comprise an account information screen, a transaction information statistics screen, a program-trading parameter screen, the program-trading parameter screen comprises at least one program-trading parameter setting screen, the account information screen displays an options product, one of the program-trading parameter setting screen comprises a total Delta value balance setting area, which comprises a first total Delta balance value setting column one, a first total Delta balance value setting column two, a first buy-sell strike setting column, a first dynamic automatic price-adjustment setting column, a first order quantity setting column, and a first automatic order time interval setting column; a transaction data statistics module, configured to receive transaction reports, which corresponding to transactions of orders, from the securities and futures company server, and perform statistics of transaction messages in the transaction reports, to generate a total call Delta value, a total put Delta value, and a total Delta value; a total Delta value balance module, configured to read the total Delta value and compare the total Delta value with values set in the first total Delta balance value setting column one and the first total Delta balance value setting column two, wherein when the total Delta value is between the values, the total Delta value balance module does not execute action, and when the total Delta value exceeds a range defined by the values set in the first total Delta balance value setting column one and the first total Delta balance value setting column two, the total Delta value balance module transmits an order to an automatic order placement integration module for placement based on the parameters set in the first buy-sell strike setting column, the first dynamic automatic price-adjustment setting column, the first order quantity setting column, and the first automatic order time interval setting column; the automatic order placement integration module, configured to place the order to the server; the memory, configured to store an application program comprising the program-trading connection module, the screen interface generation module, the total Delta value balance module, the automatic order placement integration module and the transaction data statistics module; and at least one processor, connected to the memory and the screen, and configured to execute the application program.

In some embodiments, the first dynamic automatic price-adjustment setting column is configured to set an individual order price comprising at least an immediate transaction price, a fixed price, a middle easy price, and a middle difficult price.

In some embodiments, the prices corresponding to the immediate transaction price, the fixed price, the middle easy price, and the middle difficult price are calculated based on the real-time quotation of the options product set in the program trading parameter setting column, and the order is automatically placed based on the values set in the first buy-sell strike setting column, the first order quantity setting column, and the first automatic order placement time interval setting column when an automatic order placement time set in the first automatic order placement time interval setting column is reached.

In some embodiments, the first buy-sell strike setting column comprises the options of at-the-money, forced liquidation, 1 to 3 tick(s) in-the-money, and 1 to 10 tick(s) out-of-the-money, and the first buy-sell strike setting column represents the buy-sell strike of the order.

In some embodiments, the program trading parameter setting screens further comprises an automatic retrial checkbox and an automatic retry time interval setting column, and when the automatic retrial checkbox is selected, the automatic order placement integration module cancels the order when an automatic retrial time set in the automatic retrial time interval setting column is reached, and the order is not executed.

In some embodiments, the program-trading parameter setting screen further comprises: a second total Delta balance value setting column one, a second total Delta balance value setting column two, a second buy-sell strike setting column, a second dynamic automatic price-adjustment setting column, a second order quantity setting column, a second automatic order time interval setting column; The total Delta value balance module reads the total Delta value and compare the total Delta value with second values set in the second total Delta balance value setting column one and the second total Delta balance value setting column two, when the total Delta value is between the second values, no action is executed; When the total Delta value exceeds a range defined by the second values set in the second total Delta balance value setting column one and the second total Delta balance value setting column two, parameters set in the second buy-sell strike setting column, the second dynamic automatic price-adjustment setting column, the second order quantity setting column, the second automatic order time interval setting column are transmitted to the automatic order placement integration module to place the order.

In some embodiments, each of the program trading parameter setting screen further comprises at least one priority execution function option, and each of at least one priority execution function option corresponds to the buy-sell strike setting column, the dynamic automatic price-adjustment setting column, or a restriction function setting column.

In some embodiments, the at least one priority execution function option is an intelligent strike-shifting option, which is set by a first intelligent shift point setting, a second intelligent shift point setting, a maximum intelligent shift order quantity setting, wherein the corresponding restriction function is defined in a sell-point condition column, which specifies the selling condition as a point value, when a market price of the strike price set in the buy-sell position setting column is lower than the point value, the automatic order placement integration module shifts a program selection order position in the in-the-money direction of the strike price until the program selection order position exceeds the point value, for order placement, wherein when the intelligent strike-shifting option is selected, the automatic order placement integration module prioritizes shifting the order based on a point range defined by the first intelligent shift point setting and the second intelligent shift point settings, to determine the program selection order position for order placement.

In some embodiments, the priority execution function option is a priority closing in-the-money option, which is set by a priority closing in-the-money checkbox, and a basic function option corresponding to the priority closing in-the-money checkbox is the buy-sell strike setting column, and a sell-point condition setting column, or an intelligent strike shifting option, and when the priority closing in-the-money option is selected, the automatic order placement integration module searches a prioritized position-closing position corresponding to an already executed position based on a sell-point condition set in the sell point condition setting column or the intelligent strike shifting option, to perform liquidation for meeting the sell-point condition.

In some embodiments, the priority execution functional option is an intelligent order placement option, a basic function option corresponding to the priority execution functional option is a function of executing buy-call and buy-put actions set in a buy-call options points setting column and a buy-put options points setting column, and when the intelligent order placement option is selected, the automatic order placement integration module prioritizes executing the buy order based on the greater one of difference between the sell-call order quantity and sell-call order quantity and a difference between the sell-put order quantity and sell-call order quantity.

In some embodiments, further comprising a selection function option comprising a multi-stage execution option, a full-stage execution option, or an AI intelligent execution option; wherein when the multi-stage execution option is selected, the call-to-put ratio balance module executes balancing orders in two stages based on a range defined by the second call-to-put ratio balance value column one and the second call-to-put ratio balance value column two and a range defined by the first call-to-put ratio balance value column one and the first call-to-put ratio balance value column two, respectively; wherein when the full-stage execution option is selected, the buy-sell ratio balance module executes balancing orders for the sell-call ratio at the same time based on a range defined by the second call-to-put ratio balance value column one and the second call-to-put ratio balance value column two, and a range defined by the first call-to-put ratio balance value column one and the first call-to-put ratio balance value column two; wherein when the AI intelligent execution option is selected, the buy-sell ratio balance module places a balance order for the call-to-put ratio based on the first call-to-put ratio balance value one and the first call-to-put ratio balance value column two, and calculates a maximum sell order quantity and a maximum buy order quantity based on an order quantity to be balanced and a maximum order quantity.

In some embodiments, the program-trading parameter setting screen further comprises a changed-to-buy-order due to insufficient margin setting column, and when the margin balance falls below a value set in the changed-to-buy-order due to insufficient margin setting column, sell orders are not executed but instead corresponding buy orders are executed to maintain the call-to-put ratio balance.

### BRIEF DESCRIPTION OF THE DRAWINGS

The structure, operating principle and effects of the disclosure will be described in detail by way of various embodiments, which are illustrated in the accompanying drawings.

FIG. 1 is a functional block diagram of a device according to an embodiment of the disclosure.

FIG. 2 is a functional block diagram of an application program, according to an embodiment of the disclosure.

FIG. 3 is a diagram showing an example of a whole page of a user interface according to an embodiment of the disclosure.

FIG. 4 is a diagram showing the first automatic order function interface of a user interface, according to an embodiment of the disclosure.

FIG. 5 is a diagram showing a strike option and position option screen on a user interface, according to an embodiment of the disclosure.

FIG. 6 is a diagram showing a fourth balance monitoring and order setting interface of a user interface, according to an embodiment of the disclosure.

### DETAILED DESCRIPTION

The following embodiments of the disclosure are herein described in detail with reference to the accompanying drawings. These drawings show specific examples of the embodiments of the disclosure. These embodiments are provided so that this disclosure will be thorough and complete and will fully convey the scope of the disclosure to those skilled in the art. It is to be acknowledged that these embodiments are exemplary implementations and are not to be construed as limiting the scope of the disclosure in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an”, and “the” are intended to include the plural forms as well, unless the context clearly indicates otherwise.

It is to be acknowledged that although the terms ‘first’, ‘second’, ‘third’, and so on may be used herein to describe various elements, these elements should not be limited by these terms. These terms are used only to distinguish one component from another component. Thus, the first element discussed herein could be termed a second element without altering the description of the present disclosure. As used herein, the term “or” includes all combinations of one or more of the items listed in the associated list.

It will be acknowledged that when an element or layer is referred to as being “on,” “connected to”, or “coupled to” another element or layer, it can be directly on, connected or coupled to the other element or layer, or intervening elements or layers may be present. In contrast, when an element is referred to as being “directly on,” “directly connected to”, or “directly coupled to” another element or layer, there are no intervening elements or layers present.

In addition, unless explicitly described to the contrary, the words “comprise” and “include”, and variations such as “comprises”, “comprising”, “includes”, or “including” will be acknowledged to imply the inclusion of stated elements but not the exclusion of any other elements.

The disclosure utilizes the options application programming interface (API) provided by securities and futures companies to develop an automated options trading program. By using various custom parameters, the user interface input parameters are redefined, allowing options traders to easily input their desired options order strategies through the user interface of the disclosure. Additionally, the interface generates multiple input screens for the balance strategy modules of options sellers, enabling users to easily input parameters to implement risk management for large trades. This approach allows options traders to simultaneously achieve a balance between strategy trading and risk control, significantly reducing the risks associated with large-volume trades and improving the overall success rate of options trading.

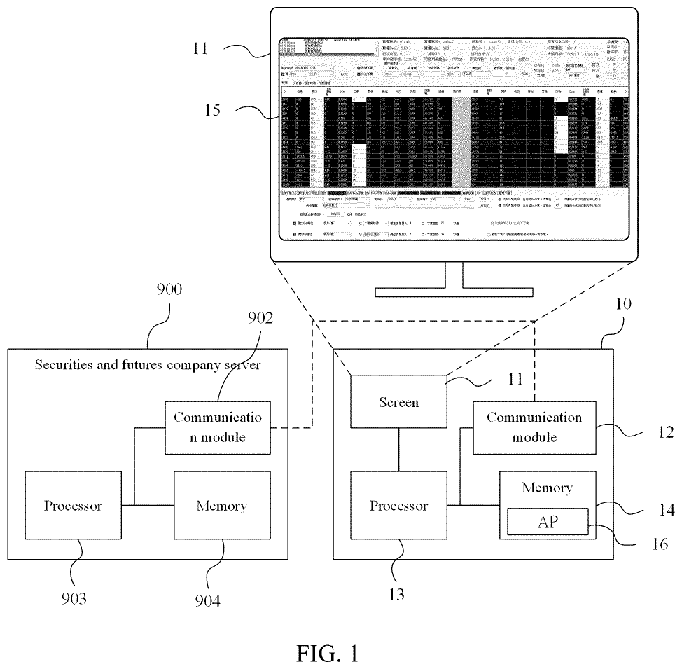

Please refer to FIG. 1, which is a functional block diagram of the device according to an embodiment of the disclosure. Unlike prior art, in the system architecture, the device 10 with automated options trading program can be implemented using a computer, preferably one with strong processing and computational capabilities. The device 10, with an automated options trading program includes a screen 11, a communication module 12, a processor 13, and memory 14. A securities and futures company server 900 includes a server communication module 902, a server processor 903, and server memory 904. Screen 11 can generate a user interface 15, providing options traders with various parameter selection options to facilitate automated trading. Additionally, through visualized information, the trader can monitor the price dynamics of the selected options financial product and the asset dynamics of their placed orders.

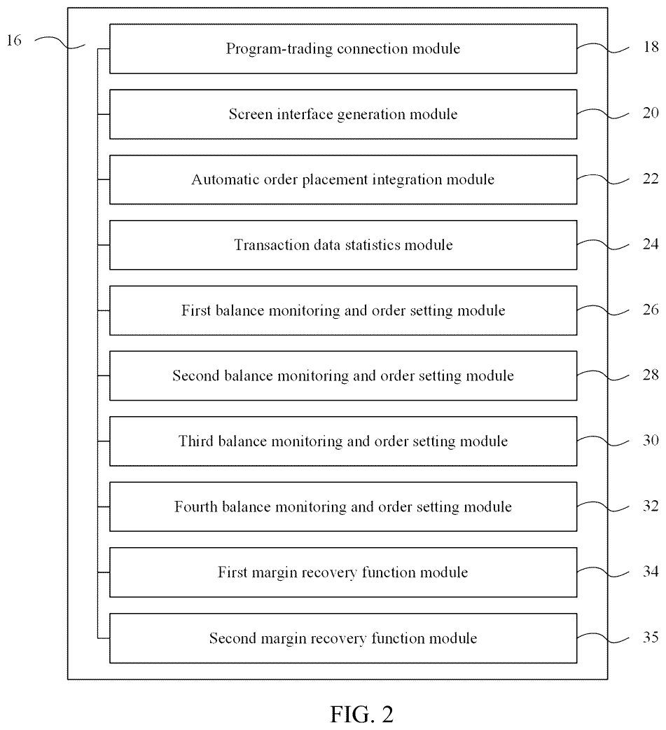

In the architecture shown in FIG. 1, device 10, with an automated options trading program is connected to the securities and futures company server 900 through their respective communication modules (communication module 12 and communication module 902). Device 10 communicates with server 900 via the application programming interface (API) downloaded and installed from the securities and futures company server 900, and device 10 utilizes the functionalities of Server 900. Since the various hardware functions in the hardware architecture have been disclosed in prior art, they will not be elaborated further here. Below, the collaboration between the components of device 10 and the application program 16 (shown in FIG. 2) will be detailed, showing how they work in conjunction with the securities and futures company server 900 to achieve the objectives of the disclosure, thereby highlighting the innovative aspects of the disclosure.

Please refer to FIG. 2, which is a functional block diagram of an application program according to an embodiment of the disclosure. The application program 16 mainly includes a program-trading connection module 18, a screen interface generation module 20, an automatic order placement integration module 22, a transaction data statistics module 24, a first balance monitoring and order setting module 26, a second balance monitoring and order setting module 28, a third balance monitoring and order setting module 30, a fourth balance monitoring and order setting module 32, a first margin recovery function module 34, a second margin recovery function module 35, a dual-sell position setup setting module 36-1, a dual-buy position setup module 36-2, a spread position setup module 36-3, a steady liquidation setting module 37-1, a designated liquidation setting module 37-2, a scaling strategy setting module 37-3, a long-short balance parameter setting module 37-4, an intelligent strike shifting function module 37-5, and a fully automatic trading control module 39.

The application program 16 is stored in memory 14, and the processor 13 executes the modules in the application program. In addition, the application program 16 communicates with the communication module 12 controlled by different modules and the server communication module 902 of the securities and futures company server 900, to transmit information such as the user account, password, credentials provided by the securities and futures company, and dynamically uploads order information stored in memory 14, and also receive financial product information, trade reports, and other data downloaded from the securities and futures company server 900, or any data requested by the various modules of application program 16. The program-trading connection module 18 includes the aforementioned application programming interface (API) downloaded from the securities and futures company server 900. This module can translate the commands generated by each module of the application program 16 into the format required by the securities and futures company server 900, which is part of the prior art and will not be discussed in detail here.

The screen interface generation module 20 is configured to generate the user interface 15. After the application program 16 is executed, it begins to run various background modules and connects to the securities and futures company server 900 through the program-trading connection module 18. Additionally, the screen interface generation module 20 creates the user interface 15. Before the user interface 15 is generated, the various background modules executed by the application program 16 fall under the scope of prior art and are not elaborated here. The disclosure only focuses on explaining the innovative aspects related to the disclosure, succinctly detailing the necessary technical features and unique technological characteristics.

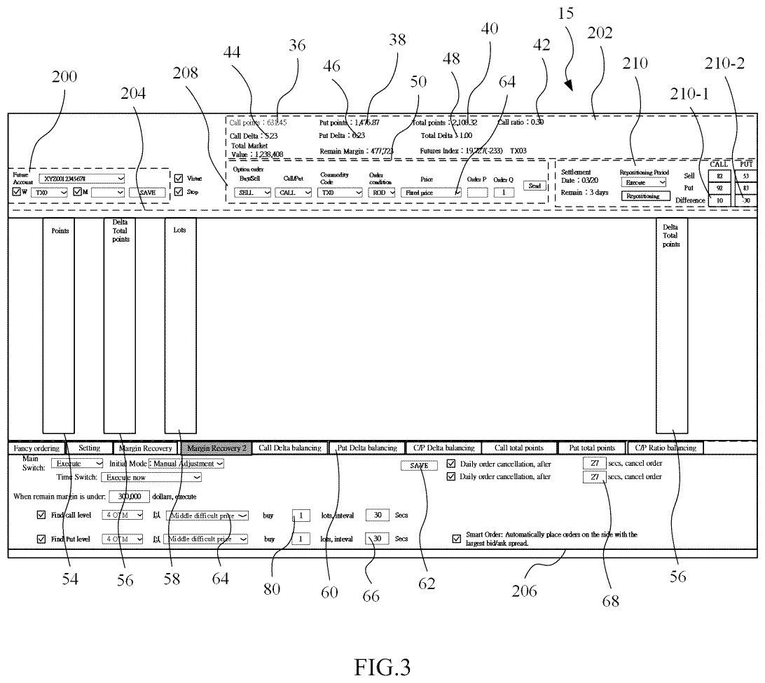

Please refer to FIG. 3, which is a diagram showing a whole screen example of the user interface 15, according to an embodiment of the disclosure. After successfully logging into the securities and futures company server 900, the screen interface generation module 20 downloads relevant data from the securities and futures company server 900 through the program-trading connection module 18. Then, the transaction data statistics module 24 processes the corresponding data and fills it into the various screens of the user interface 15. The screens are an account Information screen 200, a transaction information statistics screen 202, a real-time financial product information screen 204, a program-trading parameters screen 206, a manual order placement screen 208, and a buy-sell order quantity and difference statistics screen 210. In the embodiment of FIG. 3, various functional module screens are integrated into a single page for the convenience of the user, allowing them to easily view all the functional module screens at a glance. In another embodiment of the disclosure, the user interface may also adopt a tabbed navigation system, where users can click to select different functional module screens or use a paging method to navigate between different functional screens. The program-trading parameter screens 206, including the various program trading parameter settings 60, can be selected via tabs. Similarly, the program trading parameter screens 206 can also be navigated through other methods such as paging buttons, scrolling up or down, and so on.

The account information screen 200 displays the user's account details, the selected options product (TX0), and the corresponding month. This is aligned with the real-time product information in the financial product real-time information screen 204. The transaction information statistics screen 202 shows the transaction information of the placed orders and related statistical information. The embodiment is shown in FIG. 3 is designed from the perspective of the seller. The transaction information statistics screen 202 includes at least the following details: a call points 36 (the total number of call options points sold by the account), a put points 38 (the total number of put options points sold by the account), A total point 40 (the total number of points the account has sold, which is the sum of the call and put options points), a call option ratio 42 (this ratio indicates the proportion of call options sold in relation to the total points sold, and it is calculated as: call option ratio=call options point 36/(call options point 36+put options point 38)), a call Delta 44 (a sum of call options set in the total Delta point column 56; in the real-time financial product information screen 204, the total Delta for call options set in the total Delta point column 56 is calculated by summing the Delta values of all the sold call option contracts at different strike prices, and indicates the statics of Delta value for call options sold in this account), a put Delta 46 (a sum of put options set in the total Delta point column 56; in the real-time financial product information screen 204, the total Delta for put options set in the total Delta point column 56 is calculated by summing the Delta values of all the sold put option contracts at different strike prices, and indicates the statics of Delta value for put options sold in this account), total Delta 48 (the call Delta 44 plus the put Delta 46; it refers to the index of financial products; every increase of 1 point will affect the total points by 40 points.), and an available margin 50 (the amount of available margin in the account at that moment).

The above information column is calculated by the transaction data statistics module 24, based on the execution report data corresponding to the orders sent from the account, that is, the transaction reports returned by the securities and futures company server 900. In addition to recording the execution report data, the transaction data statistics module 24 also performs several special calculations: the call point 36, the put point 38, the total point 40, the call option ratio 42, the call Delta 44, the put Delta 46, the total Delta 48, etc. These data are all recalculated by the transaction data statistics module 24. Furthermore, the call option ratio 42 and total Delta 48 parameters can be used in the subsequent automated risk-balancing strategy, which is a unique technical feature of the disclosure and has not been disclosed in any prior art. Through the information displayed on the transaction information statistics screen 202, the account's options traders can clearly see the executed information for their option seller positions and thus understand the specific execution results and the customized balance parameter results of the options program trading for that account. Furthermore, those skilled in the art of this technical field should understand that the Delta value is one of the ‘options risk coefficients. It is denoted by the Greek letter, and the Delta value corresponding to the strike price of each stock index option is calculated by the corresponding securities exchange, not by the disclosure itself. The ‘options risk coefficient’ represents the risk coefficient of changes in the option premium (Greek), or what some call the option Greek letters or option parameters. Delta (δ) is defined as follows: under constant conditions, when the underlying asset increases by 1 point, the option premium changes by x points. For example, if delta=0.5, it means that if the underlying asset increases by 1 point, the option premium will increase by 0.5 points.” For example, Gamma (γ) is defined as: under constant conditions, when the underlying asset increases by one point, the Delta changes by x. The disclosure calculates the Delta value by applying a standard formula to the real-time option price data downloaded from the securities exchange (each strike price has a corresponding Delta value). After multiplying each Delta value by the number of contracts corresponding to each strike price, the call option Delta 44 and put option Delta 46 are obtained. The total Delta 48 is then calculated by adding the call option Delta 44 and the put option Delta 46. This calculation method has not been disclosed in any prior art. More specifically, prior art calculates Delta using a one-to-one basis, meaning that a Delta value generated from one buy-sell pair on the call side will produce a corresponding negative Delta value on the put side, and the sum of the two will equal zero. The disclosure calculates a completely new call option total Delta value and total put Delta value by multiplying the calculated Delta value by the number of contracts of the corresponding positions. Furthermore, by adding the call option total Delta value and the total put Delta value, a new concept of calculating the total Delta value is obtained. In addition, the calculation of the total call Delta value, total put Delta value, and the total Delta value in the disclosure can be based on either the options trading data or the corresponding futures trading data. In other words, the total call Delta value, the total put Delta value, and total Delta value referred to in the disclosure are not limited to those calculated from options trading data; they also include those calculated from corresponding futures trading data. Subsequently, specific embodiments will illustrate how the total Delta 48 is used in risk balancing for options program trading.

The financial product real-time information screen 204 displays financial product information downloaded from the securities and futures company server 900. For example, in the implementation shown in FIG. 3, real-time quotation information for the Taiwan Index options (TXO) is displayed. Additionally, it includes certain statistical data calculated by the transaction data statistics module 24, such as a point column 54, a total Delta point column 56, and an order quantity column 58. The points column 54 represents the points sold at various strike prices, calculated by multiplying the transaction price at a given strike price by the corresponding sell order quantity. The total Delta points in column 56 are described as before. The order quantity column 58 indicates the total number of orders sold for each strike price.

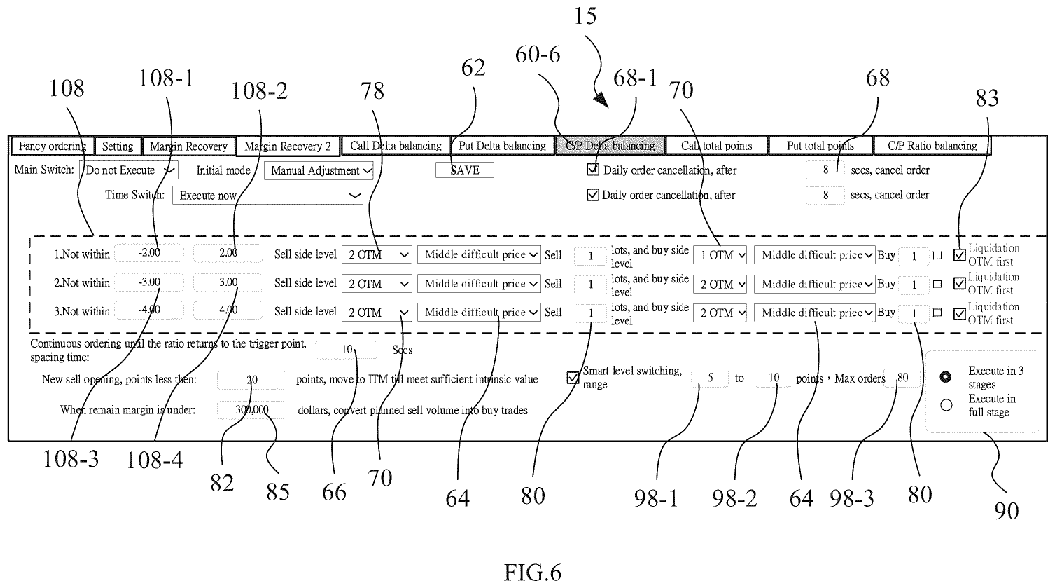

The program trading parameter screen 206 is the most important innovative aspect of the disclosure. It corresponds to multiple different automatic program order placement modules (various position-setup modules), a risk-balancing module, a margin recovery module, and a liquidation module. By implementing a parameterized program trading interface, the disclosure allows users to easily adjust trading parameters dynamically and in real-time. This enables automatic order placement, dynamic adjustment of automatic order placement parameters, automatic risk-balancing adjustments, automatic position closing, and other specialized technical functions. In FIG. 3, the program trading parameter screen 206 represents the state where the screen interface generation module 20 is simultaneously executing multiple program trading parameter setting screens 60. Currently, it is running: the second margin recovery setting screen 60-8, the total call options point control parameter setting screen 60-1, the total put options point control parameter setting screen 60-2, and the fourth balance monitoring and order placement setting screen 60-6 (as shown in the embodiment of FIG. 6). In this embodiment of FIG. 3, each program trading parameter setting screen 60 contains multiple parameters for different program trading executions. The built-in trading logic will be explained later in the descriptions of each screen and functional module. FIG. 3 displays the second margin recovery setting screen 60-8. The main parameter setting columns include a dynamic automatic price-adjustment setting column 64, an order quantity setting column 80, an automatic order placement time interval setting column 66, and an automatic recovery time interval setting column 68. Additionally, in this embodiment of FIG. 3, switching between different parameter setting screens within the program trading parameter screen 206 is done using tab selection. As mentioned earlier, switching can also be performed by scrolling up and down or using left and right sliding buttons. In other words, the switching methods fall within the scope of prior technology and will not be further elaborated on here.

The manual order placement screen 208 is a traditional order placement interface that includes the necessary input columns for each order, such as trade direction, option type, product code, order conditions (ROD, etc.), price type, order price, and order quantity. The price type column utilizes the specially developed dynamic automatic price-adjustment setting column 64, which will be explained later. For option traders who do not wish to use the programmatic automatic order placement mode of the disclosure, the manual order placement screen 208 can also be used to place orders one by one.

The buy-sell order quantity and difference statistics screen 210 compiles statistics on the current number of call and put option orders bought and sold. It also calculates the difference of 210-1 between the number of call options sold and bought and the difference of 210-2 between the number of put options sold and bought. The calculated values of the call option difference 210-1 and the put option difference 210-2 from this screen are used for margin recovery and various balance monitoring strategies.

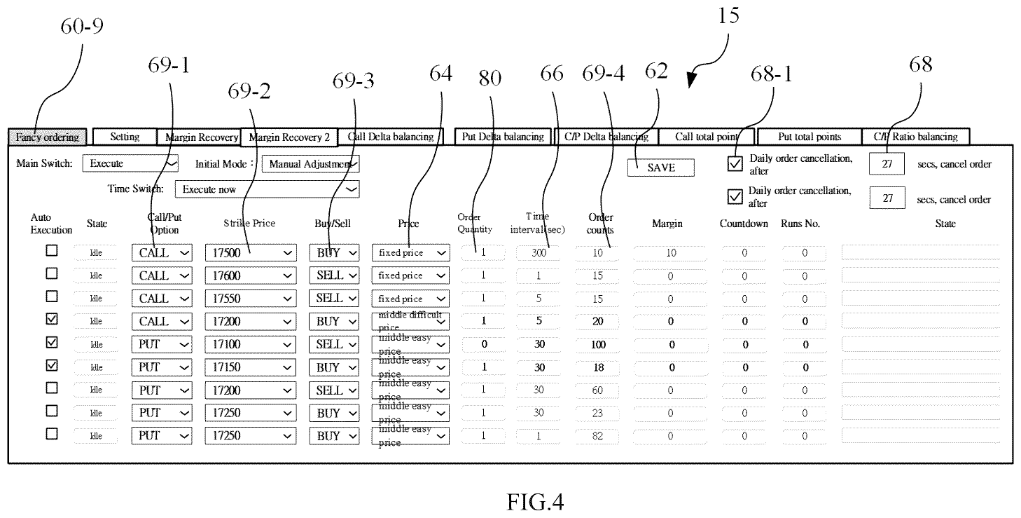

The automatic trading parameter setting modules in FIG. 2 will be explained through various parameter setting screens. First, refer to FIG. 4, which is an example of a user interface according to an embodiment of the disclosure. It shows the automatic order placement function interface, specifically the custom order placement method parameter setting screen 60-9 (also referred to as the manual automatic order placement parameter input setting screen). This screen includes at least the following parameter setting columns: a call/put option parameter setting column 69-1, a strike price setting column 69-2, a buy-sell setting column 69-3, an automatic order placement count setting column 69-4, a dynamic automatic price-adjustment setting column 64, an order quantity setting column 80, an automatic order placement time interval setting column 66, an automatic recovery time activation setting column 68-1, an automatic recovery time interval setting column 68, and a parameter save button 62. The screen interface generation module 20 generates various functional module screens, and each of the functional module screens contains different parameter setting columns, as shown in FIG. 4. Users under the same account can easily implement option program trading strategies and parameter settings by inputting values into these parameter setting columns. In the embodiment shown in FIG. 4, the parameters are used by the automatic order placement integration module 22. The user only needs to set the values for each row, including the call/put option parameter setting column 69-1, a strike price setting column 69-2, a buy-sell setting column 69-3, an automatic order placement count setting column 69-4, a dynamic automatic price-adjustment setting column 64, an order quantity setting column 80, and other columns. Finally, by pressing the parameter save button 62, these parameters are saved in memory 14. Subsequently, the automatic order placement integration module 22 will use these settings to place orders.

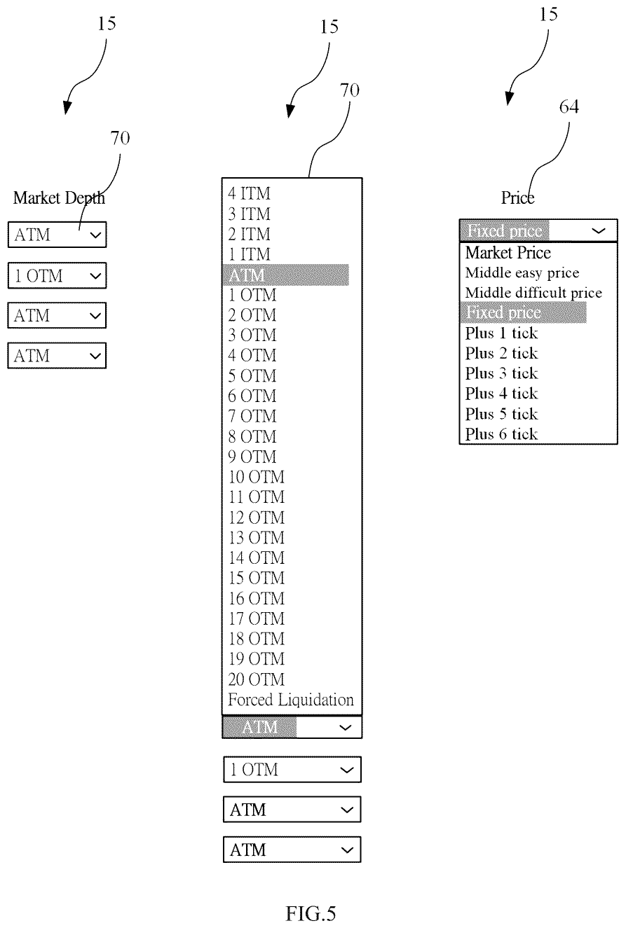

What is particularly special are the automatic order placement time interval setting column 66, the automatic recovery time activation setting column 68-1, and the automatic recovery time interval setting column 68. The settings of these three columns are closely related to the dynamic automatic price-adjustment setting in column 64. The configuration and integration of these columns are also one of the main technical features of the disclosure. The automatic order placement time interval setting column 66 is used to set the automatic order placement time for each order. The time set in the automatic recovery time interval setting column 68 is used to automatically delete the order if it has not been executed within the time set in the automatic order placement time interval setting column 66. The disclosure uses the concept of a dynamic automatic price-adjustment setting column 64, as shown in FIG. 5. In the embodiment of FIG. 4, for the first row, the values in a call/put option parameter setting column 69-1, a strike price setting column 69-2, a buy-sell setting column 69-3, an automatic order placement count setting column 69-4, a dynamic automatic price-adjustment setting column 64, and order quantity setting column 80 are “call,” “17500,” “BUY,” “fixed price,” “1,” “300,” and “10,” respectively. For the fifth row, the values in the same columns are “Put,” “17100,” “SELL,” “middle easy price,” “1,” “30,” and “100,” respectively. Each row has different settings. Please refer to FIG. 5. The dynamic automatic price-adjustment setting column 64 has several basic settings, including: “immediate transaction price,” “middle easy price,” “middle difficult price,” “fixed price,” “plus one tick price,” “plus two tick price,” “plus three tick price,” “plus four tick price,” “plus five tick price,” and “plus six tick price.” This setting method is different from the commonly used “Market price” and “Limit price” settings. The “immediate transaction price” refers to the price offered by the counterparty (usually with a slight discount from the counterparty's price). For example, when the user is the buyer at a particular strike price, the user will place a buy order at the price of the seller's sell order, which will be immediately executed. The opposite holds true for the seller. The “fixed price” refers to the current market price. For example, if the user is the buyer, the price will be based on the current price offered by other buyers. For Example, when the strike price is 19500, and the real-time quote shows that the buy price for the call option is 150 and the sell price is 160, the transaction price will be 153. In this case, when the user selects a different price level in the dynamic automatic price-adjustment setting column 64, the automatic order placement integration module 22 will dynamically adjust the order price based on the current buy and sell prices for the call option. The middle easy price is the price that falls between the current prices offered by both the buyer and the seller, skewed toward the counterparty's price, while the middle difficult price is the price that falls between the current prices offered by both the buyer and the seller, skewed in favor of the counterparty's price. There are several methods for determining these prices: 1. The middle easy price is selected by moving one tick from the immediate transaction price toward the fixed price, whereas the middle difficult price is selected by moving one tick from the fixed price toward the immediate transaction price. 2. The middle easy rice is selected by moving one tick from the middle price between the immediate transaction price and the fixed price toward the immediate transaction price, whereas the middle difficult price is selected by moving one tick from the middle price between the immediate transaction price and the fixed price toward the fixed price. Other configurations are possible for the middle price between the immediate transaction price and the fixed price. For the embodiment of this method, if the order is a buy order, the “immediate transaction price” is 160, the “middle easy price” is calculated as (150+160)/2+1, the “middle difficult price” is (150+160)/2−1, the “fixed price” is 150, and the “plus one tick price” is 150−1, “plus two tick price” is 150−2, “plus three tick price” is 150−3, “plus four tick price” is 150−4, “plus five tick price” is 150−5, and “plus six tick price” is 150−6. In contrast, if the order is a sell order, the “immediate transaction price” is 150, the “middle easy price” is calculated as (150+160)/2−1, the “middle difficult price” is (150+160)/2+1, the “fixed price” is 160, “plus one tick price” is 160+1, “plus two tick price” is 160+1, “plus three tick price” is 160+1, “plus four tick price” is 160+1, “plus five tick price” is 160+1, and “plus six tick price” is 160+1. When the user selects a specific price setting, the automatic order placement integration module 22 dynamically generates the order prices for each price setting based on the current buy and sell prices of the call options. This is the technical concept behind the “dynamic automatic price-adjustment setting column 64.” In other words, the purpose of the “immediate transaction price” is to ensure a quick execution, but it may not necessarily be the most favorable price for the buyer or seller. The “fixed price” represents the price that other buyers or sellers are willing to offer at that moment, which is the most favorable for the buyer or seller but is relatively harder to execute. The “middle easy price” is easier to execute than the “fixed price,” but it may be less favorable to the buyer or seller. The “middle difficult price” is harder to execute than the “fixed price,” but it offers a more favorable price to the buyer or seller. The “plus n tick price n” is the most favorable for the buyer or seller but is even more difficult to execute. The “dynamic automatic price-adjustment setting column 64” allows the user of the account to experiment with different dynamically adjusted order prices, helping to determine whether the focus is on quick execution to open a position or achieving the best possible execution price. Through this feature of the disclosure, the user can more flexibly design their program trading parameters.

The “dynamic automatic price-adjustment setting column 64” allows the user to choose the price levels for dynamically adjusting the difficulty of execution. When combined with the “automatic order time interval setting column 66,” “automatic recovery time activation setting column 68-1,” and “automatic recovery time interval setting column 68,” it holds greater technical significance. When the execution difficulty is high, the user can adjust the order time interval to a shorter setting in the “automatic order time interval setting column 66” and the deletion time interval in the “automatic recovery time interval setting column 68.” Alternatively, the user can adjust the “automatic order count setting column 69-4” to increase the number of orders placed, thereby improving the probability of execution by continuously placing orders. Through trial and error, the user can gradually master the optimal settings for these columns.

In another embodiment of the disclosure, the definition of the dynamic automatic price-adjustment setting column 64 can also adopt the concept of existing market orders and limit orders for the user to choose from.

The embodiment shown in FIG. 4 explains that the disclosure can perform automated program trading by clicking, entering data, and saving in the various program trading parameter columns of the custom order method parameter setting screen 60-9. After filling in and saving the parameters, when the user clicks to execute, the automatic order placement integration module 22 retrieves the set parameters to perform automatic order placement and automatic recovery. Subsequently, the transaction results can be viewed in the transaction information statistics screen 202, as previously described.

The parameters of the buy-sell position setting column 70 are shown in FIG. 5. The buy-sell position setting column 70 provides various settings for bid/ask levels (also referred to as adjustable strike prices), such as ‘four ticks in-the-money’ to ‘one tick in-the-money,’ ‘one tick out-of-the-money’ to ‘20 ticks out-of-the-money,’ ‘at-the-money,’ and ‘forced liquidation.’ These options allow users to set automatic buy-sell strike price levels, which will dynamically adjust in response to the index changes of the underlying asset, i.e., the option product. This is one of the key technical features of the disclosure. When combined with the dynamic automatic price-adjustment setting column 64, the user does not need to input any fixed strike prices (as in the embodiment of FIG. 4) or fixed ‘limit prices’ (as in prior art) in the program, thus achieving the dynamic self-adaptive generation of strike prices and order prices, a unique technical effect.

Please refer to FIG. 8, which shows an embodiment of the user interface for the fourth balance monitoring and order setting screen. This interface is designed for the total Delta value balance method's settings and orders. The key difference in FIG. 6 is that the fourth balance monitoring and order setting screen 60-6 provides the total Delta value balance setting area 108, which includes three levels of total Delta value balance intervals. The total Delta value refers to the total Delta 48 in the transaction information statistics screen 202 shown in FIG. 3. In other words, the total Delta value balance method is a risk control method that balances the total Delta value 48, where the balance is achieved through the ratio of call/put options. The main difference in the total Delta value balance setting area 108 is the following parameter setting columns: a first total Delta value balance setting column 108-1 and a second total Delta value balance setting column 108-2 for a first stage, and the first total Delta value balance setting column 108-3 and the second total Delta value balance setting column 108-4 for a second stage.

Taking FIG. 6 as an example, the first total Delta value balance setting column 108-1 and the second total Delta value balance setting column 108-2 are set to not between −2 and 2. When this setting is executed, if the total Delta value 48 is greater than 2 or less than −2, the corresponding automatic buy or sell orders set behind these columns will be triggered until the total Delta value 48 returns to the range of −2 to 2. Similarly, the first total Delta value balance setting column 108-3 and the second total Delta value balance setting column 108-4 are set to not between −3 and 3. When this setting is executed, if the total Delta value 48 is greater than 3 or less than −3, the corresponding automatic buy or sell orders set behind these columns will be triggered until the total Delta value 48 returns to the range of −3 to 3. The third stage functions similarly to the previous example, so it is not further repeated herein.

Additionally, the embodiment in FIG. 6 includes a changed-to-buy-order due to insufficient margin setting in column 85. The setting in this column dictates that when the margin balance falls below its value, sell orders will not be placed. Instead, corresponding buy orders will be placed to maintain the total Delta balance (“the designated sell order quantities are replaced by buy orders”).

The total Delta value balancing method shown in FIG. 6 is a unique invention. It is suitable for options traders who have large sell positions on both the call and put sides. The embodiment in FIG. 6 employs the sum of the sold call Delta 44 (total call Delta value) and the sold put Delta 46 (total put Delta value) to obtain the total Delta 48 value, which is used for the “balancing” technical concept. Since total Delta 48 represents the financial product's index, each 1-point increase affects the total point value 40; options traders can use the total Delta 48 value to determine how to adjust when the options product is in a major uptrend or downtrend. In other words, for an options trader who has sold large numbers of calls or put contracts at various strike prices and has significant positions on both the call and put sides, the total Delta value 48 can be locked within a pre-set range. This ensures that the entire sold position does not deviate from the trader's intended range, thus reducing overall settlement risk. This method of allowing the user to set their own risk balance point is one of the unique technical features of the disclosure.

The embodiment in FIG. 6 demonstrates how the disclosure can automatically execute total Delta balance monitoring by using the fourth balance monitoring and order setting screen 60-6. After clicking, entering data, and saving the various program trading parameter columns, the fourth balance monitoring and order setting module 32 uses the stored parameters to carry out the automated total Delta balance supervision. Once the triggering conditions are met, the system passes the data to the automated order integration module 22 for total Delta balance orders. These orders will continue until the total Delta value 48, calculated by the transaction data statistics module 24, returns to the set range, at which point the process stops until the next trigger occurs. In other words, once the fourth balance monitoring and order setting screen 60-6 is completed, saved, and executed, the fourth balance monitoring and order setting module 32 continuously compares, monitors, and transmits the total Delta value 48 and order instructions. The results can later be viewed in the transaction information statistics screen 202, as mentioned earlier.

In summary, the first balance monitoring and order setting module 26, the second balance monitoring and order setting module 28, the third balance monitoring and order setting module 30, and the fourth balance monitoring and order setting module 32 are each independent modules that can operate individually or work together in collaboration. However, since their triggering conditions are different, the processing demand for processor 13 will increase as more balance monitoring modules operate together.

Furthermore, the automated order integration module 22, the first balance monitoring and order setting module 26, the second balance monitoring and order setting module 28, the third balance monitoring and order setting module 30, and the fourth balance monitoring and order setting module 32 are all risk balance monitoring modules for options trading. Each balance monitoring module has a corresponding activation button; if not activated, the parameters set in the corresponding module will not be executed.

Many options traders tend to operate as sellers of both call and put options. To reduce trading costs and minimize slippage, during the initial stage of position setup, they generally prefer to use a strategy of naked selling on both sides, with the best option being the ROD (Random order Directed) naked selling trading model. However, this trading model requires the highest margin, unlike strategies that involve buying combinations, where the margin requirement can be surprisingly high, significantly limiting the number of contracts that an options trader can sell. Previous techniques have simply reminded traders to use combination strategies for their trades. However, combination strategies are costly, suffer from high slippage, and offer poor flexibility, as they must be placed one by one. As a result, most options traders seldom adjust their positions once they adopt a combination strategy,. This makes it very inconvenient for large traders. To address this issue, the disclosure provides an automatic margin recovery function. When multiple contracts are executed in a one-sided naked selling mode, the system automatically recovers the margin based on predefined conditions, allowing the program to manage the margin more efficiently and enabling the seller to increase the number of contracts they sell.

From the above embodiment, it can be seen that the application scenario is based on an options program trader executing the process on their own computer. A person with ordinary skill in the technical field of the disclosure would understand that the technical content of the disclosure can also be directly applied to the securities and futures company's server or to the software development company's server. In other words, the “securities and futures company server” in the above embodiment would be replaced by the securities exchange server (with the program installed on the securities and futures company server), and both are equivalent. In this type of application scenario, if the disclosure's fully automated artificial intelligence options dual-sell balancing trading program is installed on the securities and futures company's server or the software development company's server, the options trader can use their computer to connect to the web server and then directly interact with the securities and futures company's server or the software development company's server to place orders with the relevant entity, such as the Taiwan Stock Exchange. In such an application scenario, there is no need to install an application programming interface (API). By using the web server, the trader can log in with their account credentials, certificates, etc., and utilize the securities and futures company's server or the software development company's server for automated trading. In other words, by using the technical content of the disclosure, the securities and futures company or the software development company can provide options program trading services. If it is the software development company's server, it still needs to connect to the securities and futures company's server. This connection method is part of the prior art and will not be elaborated on here. Therefore, the “device with the fully automated artificial intelligence trading program for options (with designated position closing function)” referred to in the disclosure can be a personal computer or a server of the securities and futures company or the software development company. In this context, the “server” in the disclosure can be the securities and futures company's server, the software development company's server, or the securities exchange's server, depending on where the fully automated AI options dual-sell balancing trading program is installed.

From the above embodiments, the disclosure employs various technical features to achieve different objectives and produce unique technical effects. First, the solution of the disclosure can make options program trading parameter settings interface-based. Through the program trading parameter screen 206, the disclosure allows various order placement modes to be easily set by selecting and inputting through different trading parameter setting screens, achieving the unique technical effect of completing program trading design via an interface without the need to write code. Secondly, the disclosure can automatically adjust the order price for options: designed with the “dynamic automatic price-adjustment setting column” option so that users are allowed to select the automatically generated price based on the concept of successful transaction probability to achieve the unique technical effect of flexible and automated price generation. Thirdly, the disclosure can automatically balance after a large options position is built to reduce risk. The disclosure achieves risk balance automatically through various balance monitoring modes and parameter settings, realizing the unique technical effect of dynamically reducing investment risk and improving the overall win rate. Fourthly, the disclosure can automatically recover the margin after large options sell position is built. The disclosure uses margin recovery parameter settings, and when the margin falls below the set value, it automatically buys the specified call or put options to recover the margin, achieving the unique technical effect of optimizing investment capital. Fifthly, the disclosure can realize fully automated artificial intelligence options for dual-sell balancing trading, which is one of the main objectives of the disclosure. Through the various parameter settings mentioned above, the disclosure's fully automated artificial intelligence options dual-sell balancing trading program, once the parameters for automated trading are established through the various setting screens, can automatically build a multi-position strategy for dual-selling. It then uses various balancing parameters, margin recovery, and other mechanisms to achieve fully automated trading, fully automated risk control, and options program trading with no further user intervention.

It can be understood from the different embodiments of the disclosure that the program instructions executed by the computer can perform the functions of each functional block and their combinations in the functional block diagram, as well as the steps in each embodiment. After providing each program instruction to the processor for execution, the effect of hardware and software cooperation can be achieved. Thus, when the program instructions are executed on the processor, they will generate actions or technical effects as specified in the flowchart and functional blocks. In addition, without departing from the scope or spirit of the disclosure, one or more functional blocks or different combinations of functional blocks in the flowchart may also be performed simultaneously with other processes or functional block combinations or in a sequence different from that described in the specification.

The disclosure disclosed herein has been described by means of specific embodiments. However, numerous modifications, variations and enhancements can be made thereto by those skilled in the art without departing from the spirit and scope of the disclosure set forth in the claims.

What is claimed is:

1. A device with a fully automated AI dual-sell options (futures) balancing trading program, wherein the device comprises a memory and a screen and is connected to a server, and the device comprises:
a communication module, configured to establish an Internet network connection and connected to the server;
a program-trading connection module;
a screen interface generation module, configured to generate a user interface on the screen, wherein the user interface at least comprises an account information screen, a transaction information statistics screen, a program-trading parameter screen, the program-trading parameter screen comprises at least one program-trading parameter setting screen, the account information screen displays an options product, one of the program-trading parameter setting screen comprises a total Delta value balance setting area, which comprises a first total Delta balance value setting column one, a first total Delta balance value setting column two, a first buy-sell strike setting column, a first dynamic automatic price-adjustment setting column, a first order quantity setting column, and a first automatic order time interval setting column;
a transaction data statistics module, configured to receive transaction reports, which corresponding to transactions of orders, from the securities and futures company server, and perform statistics of transaction messages in the transaction reports to generate a total call Delta value, a total put Delta value, and a total Delta value;
a total Delta value balance module, configured to read the total Delta value and compare the total Delta value with values set in the first total Delta balance value setting column one and the first total Delta balance value setting column two, wherein when the total Delta value is between the values, the total Delta value balance module does not execute action, and when the total Delta value exceeds a range defined by the values set in the first total Delta balance value setting column one and the first total Delta balance value setting column two, the total Delta value balance module transmits an order to an automatic order placement integration module for placement based on the parameters set in the first buy-sell strike setting column, the first dynamic automatic price-adjustment setting column, the first order quantity setting column, and the first automatic order time interval setting column;
the automatic order placement integration module, configured to place the order to the server;
the memory, configured to store an application program comprising the program-trading connection module, the screen interface generation module, the total Delta value balance module, the automatic order placement integration module and the transaction data statistics module; and
at least one processor is connected to the memory and the screen and configured to execute the application program.

2. The device with a fully automated AI dual-sell options (futures) balancing trading program according to claim 1, wherein the first dynamic automatic price-adjustment setting column is configured to set an individual order price comprising at least an immediate transaction price, a fixed price, a middle easy price, and a middle difficult price.

3. The device with a fully automated AI dual-sell options (futures) balancing trading program according to claim 2, wherein the prices corresponding to the immediate transaction price, the fixed price, the middle easy price, and the middle difficult price are calculated based on the real-time quotation of the options product set in the program trading parameter setting column, and the order is automatically placed based on the values set in the first buy-sell strike setting column, the first order quantity setting column, and the first automatic order placement time interval setting column when an automatic order placement time set in the first automatic order placement time interval setting column is reached.

4. The device with a fully automated AI dual-sell options (futures) balancing trading program according to claim 1, wherein the first buy-sell strike setting column comprises the options of at-the-money, forced liquidation, 1 to 3 tick(s) in-the-money, and 1 to 10 tick(s) out-of-the-money, and the first buy-sell strike setting column represents the buy-sell strike of the order.

5. The device with a fully automated AI dual-sell options (futures) balancing trading program according to claim 3, wherein the program trading parameter setting screens further comprises an automatic retrial checkbox and an automatic retry time interval setting column, and when the automatic retrial checkbox is selected, the automatic order placement integration module cancels the order when an automatic retrial time set in the automatic retrial time interval setting column is reached and the order is not executed.

6. The device with a fully automated AI dual-sell options (futures) balancing trading program according to claim 3, wherein the program-trading parameter setting screens further comprises:
a second total Delta balance value setting column one, a second total Delta balance value setting column two, a second buy-sell strike setting column, a second dynamic automatic price-adjustment setting column, a second order quantity setting column, a second automatic order time interval setting column; the total Delta value balance module reads the total Delta value and compare the total Delta value with values set in the second total Delta balance value setting column one and the second total Delta balance value setting column two, when the total Delta value is between the second values, no action is executed; when the total Delta value exceeds a range defined by the second values set in the second total Delta balance value setting column one and the second total Delta balance value setting column two, parameters set in the second buy-sell strike setting column, the second dynamic automatic price-adjustment setting column, the second order quantity setting column, the second automatic order time interval setting column are transmitted to the automatic order placement integration module to place the order.

7. The device with a fully automated AI dual-sell options (futures) balancing trading program according to claim 3, wherein each of the program trading parameter setting screen further comprises at least one priority execution function option, and each of at least one priority execution function option corresponds to the buy-sell strike setting column, the dynamic automatic price-adjustment setting column, or a restriction function setting column.

8. The device with a fully automated AI dual-sell options (futures) balancing trading program according to claim 7, wherein the at least one priority execution function option is an intelligent strike-shifting option, which is set by a first intelligent shift point setting, a second intelligent shift point setting, a maximum intelligent shift order quantity setting,
wherein the corresponding restriction function is defined in a sell-point condition column, which specifies the selling condition as a point value; when a market price of the strike price set in the buy-sell position setting column is lower than the point value, the automatic order placement integration module shifts a program selection order position in the in-the-money direction of the strike price until the program selection order position exceeds the point value, for order placement,
wherein when the intelligent strike-shifting option is selected, the automatic order placement integration module prioritizes shifting the order based on a point range defined by the first intelligent shift point setting and the second intelligent shift point setting to determine the program selection order position for order placement.

9. The device with a fully automated AI dual-sell options (futures) balancing trading program according to claim 8, wherein the priority execution function option is a priority closing in-the-money option, which is set by a priority closing in-the-money checkbox, and a basic function option corresponding to the priority closing in-the-money checkbox is the buy-sell strike setting column, and a sell-point condition setting column, or an intelligent strike shifting option, and when the priority closing in-the-money option is selected, the automatic order placement integration module searches a prioritized position-closing position corresponding to an already executed position based on a sell-point condition set in the sell point condition setting column or the intelligent strike shifting option, to perform liquidation for meeting the sell-point condition.

10. The device with a fully automated AI dual-sell options (futures) balancing trading program according to claim 7, wherein the priority execution functional option is an intelligent order placement option, a basic function option corresponding to the priority execution functional option is a function of executing buy-call and buy-put actions set in a buy-call options points setting column and a buy-put option points setting column,
and when the intelligent order placement option is selected, the automatic order placement integration module prioritizes executing the buy order based on the greater difference between the sell-call order quantity and sell-call order quantity and a difference between the sell-put order quantity and sell-call order quantity.

11. The device with a fully automated AI dual-sell options (futures) balancing trading program according to claim 6, further comprising a selection function option comprising a multi-stage execution option, a full-stage execution option, or an AI intelligent execution option;
wherein when the multi-stage execution option is selected, the call-to-put ratio balance module executes balancing orders in two stages based on a range defined by the second call-to-put ratio balance value column one and the second call-to-put ratio balance value column two, and a range defined by the first call-to-put ratio balance value column one and the first call-to-put ratio balance value column two, respectively;
wherein when the full-stage execution option is selected, the buy-sell ratio balance module executes balancing orders for the sell-call ratio at the same time based on a range defined by the second call-to-put ratio balance value column one and the second call-to-put ratio balance value column two and a range defined by the first call-to-put ratio balance value column one and the first call-to-put ratio balance value column two;
wherein when the AI intelligent execution option is selected, the buy-sell ratio balance module places a balance order for the call-to-put ratio based on the first call-to-put ratio balance value one and the first call-to-put ratio balance value column two, and calculates a maximum sell order quantity and a maximum buy order quantity based on an order quantity to be balanced and a maximum order quantity.

12. The device with a fully automated AI dual-sell options (futures) balancing trading program according to claim 1, wherein the program-trading parameter setting screen further comprises a changed-to-buy-order due to insufficient margin setting column, and when the margin balance falls below a value set in the changed-to-buy-order due to insufficient margin setting column, sell orders are not executed, but instead corresponding buy orders are executed to maintain the call-to-put ratio balance.
